(19) United States
(12) Patent Application Publication
(10) Pub. No.: US 2017/0004572 A1
(43) Pub. Date: Jan. 5, 2017

(54) METHOD FOR UNIFYING FORMATS OF ELECTRONIC RECEIPTS

(71) Applicant: TOSHIBA TEC KABUSHIKI KAISHA, Tokyo (JP)

(72) Inventor: Masanori SAMBE, Mishima Shizuoka (JP)

(21) Appl. No.: 14/987,974

(22) Filed: Jan. 5, 2016

(30) Foreign Application Priority Data
Jan. 8, 2015 (JP) 2015-002608

(51) Int. Cl. G06Q 40/00; G06F 17/30

(52) U.S. Cl. CPC G06Q 40/00; G06F 17/30371

(57) ABSTRACT

A method for unifying formats of electronic receipts, includes the steps of receiving, from a first processing device, first electronic receipt data in a structured data format, the first electronic receipt data containing a user ID and transaction content corresponding to one transaction, receiving, from a second processing device, second electronic receipt data in a non-structured data format, converting the received second electronic receipt data into the structured data format, the converted second electronic receipt data containing a user ID and transaction content corresponding to one transaction, and storing the first electronic receipt data in the structured data format and the second electronic receipt data in the structured data format in a table, each entry of the table containing a user ID and transaction content corresponding to one transaction.

### CROSS-REFERENCE TO RELATED APPLICATION

This application is based upon and claims the benefit of priority from Japanese Patent Application No. 2015-002608, filed Jan. 8, 2015, the entire contents of which are incorporated herein by reference.

### FIELD

Embodiments described herein relate to a method for unifying formats of electronic receipts.

### BACKGROUND

In one electronic receipt system, an electronic receipt server stores receipt data obtained by digitizing information recorded on a receipt in an electronic receipt server. A customer who is involved in a corresponding transaction can view the receipt on a receipt viewer by accessing the electronic receipt server from an information terminal such as a computer or a smart phone via a web.

In another electronic receipt system, a server stores receipt data, and a customer may receive from the server an e-mail containing the receipt data as text data.

As a result, a customer who made purchases in a store that uses the former system and a store that uses the latter system may need to launch the viewer and open an email to view receipt data of both purchase transactions.

### DESCRIPTION OF THE DRAWINGS

FIG. 1 schematically illustrates a retail store in which a commodity sales processing system according to an embodiment is introduced.

FIG. 2 is a block diagram of the commodity sales processing system according to the embodiment.

FIG. 3 is a block diagram of a POS apparatus in the commodity sales processing system.

FIG. 4 is a block diagram of a portable information terminal in the commodity sales processing system.

FIG. 5 is a block diagram of a support server in the commodity sales processing system.

FIG. 6 illustrates a data structure of a commodity transaction file stored in a transaction file region of the support server.

FIG. 7 is a block diagram of an electronic receipt server in the commodity sales processing system.

FIG. 8 illustrates a data structure of an electronic receipt file stored in an electronic receipt region of the electronic receipt server.

FIG. 9 illustrates a data structure of an association table stored in an association table region of the electronic receipt server.

FIG. 10 is a flowchart illustrating a process carried out by a processor of the portable information terminal based on a self-service registration terminal program.

FIG. 11 is a flowchart illustrating a process carried out by a processor of the support server based on a self-service registration server program.

FIG. 12 is a flowchart illustrating a process carried out by a processor of the POS apparatus based on a settlement program.

FIG. 13 is a flowchart illustrating a process carried out by the processor of the POS apparatus based on a settlement program (a first type).

FIG. 14 is a flowchart illustrating a process carried out by the processor of the POS apparatus based on a settlement program (a second type).

FIG. 15 is a flowchart illustrating a process carried out by a processor of the electronic receipt server based on an electronic receipt server program.

### DETAILED DESCRIPTION

According to an embodiment, a method for unifying formats of electronic receipts, includes the steps of receiving, from a first processing device, first electronic receipt data in a structured data format, the first electronic receipt data containing a user ID and transaction content corresponding to one transaction, receiving, from a second processing device, second electronic receipt data in a non-structured data format, converting the received second electronic receipt data into the structured data format, the converted second electronic receipt data containing a user ID and transaction content corresponding to one transaction, and storing the first electronic receipt data in the structured data format and the second electronic receipt data in the structured data format in a table, each entry of the table containing a user ID and transaction content corresponding to one transaction.

Embodiments of a commodity sales processing system which causes a self-service registration system to cooperate with an electronic receipt system are described below with reference to the accompanying drawings.

[Commodity Sales Data Processing System]

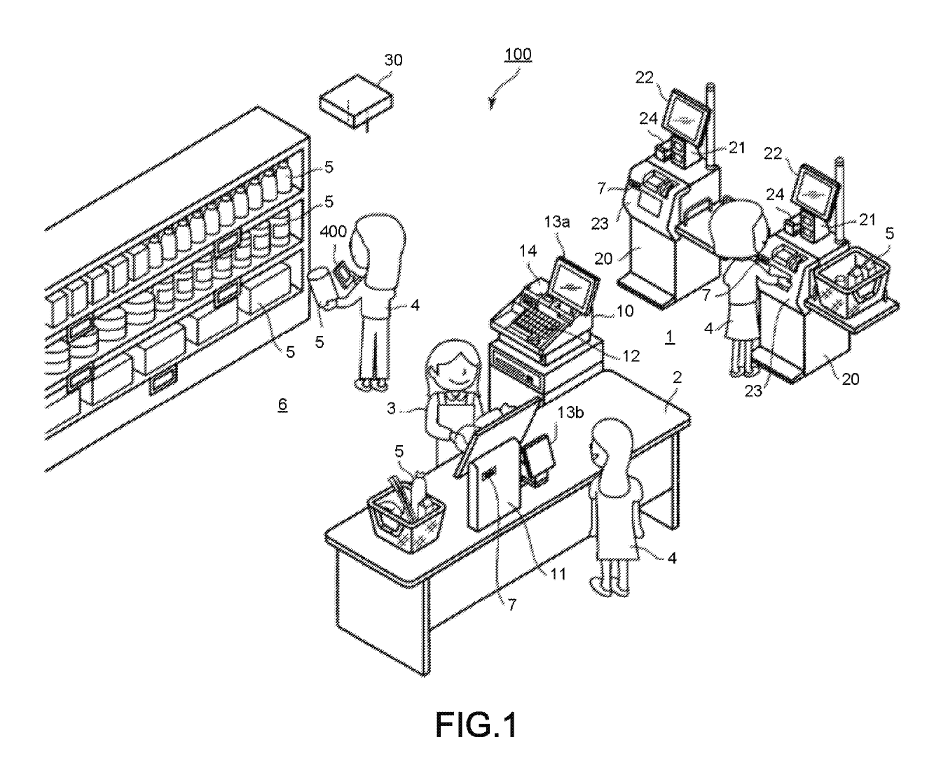

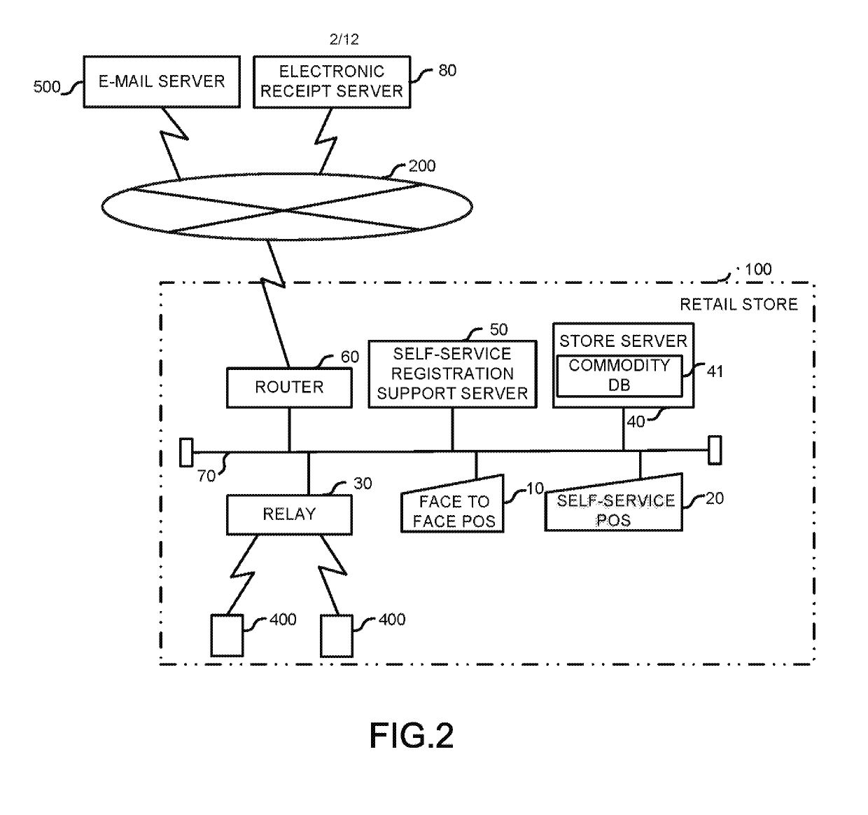

FIG. 1 is a schematic diagram of a retail store 100 having a commodity sales processing system, and FIG. 2 is a block diagram of the commodity sales processing system.

As shown in FIG. 1 and FIG. 2, the commodity sales processing system includes, in the retail store 100, a face-to-face POS (Point of Sales) apparatus 10, self-service POS apparatuses 20, and a relay 30. Further, as shown in FIG. 2, the commodity sales processing system includes, in the retail store 100, a store server 40, a self-service registration support server (hereinafter referred to as a support server) 50, and a router 60. Moreover, in the retail store 100, the commodity sales processing system includes a LAN (Local Area Network) 70 through which the POS apparatuses 10 and 20, the relay 30, the store server 40, the support server 50, and the router 60 are connected. The LAN 70 may be a wired or a wireless LAN. The router 60 relays the data communication between the LAN 70 and a network 200.

Further, the commodity sales processing system includes an electronic receipt server 80 connected with the network 200. The network 200 is, for example, an Internet or amobile communication network over which a portable information terminal 400 can access the electronic receipt server 80.

An e-mail server 500 connected with the network 200 stores e-mail data containing an e-mail address designating the electronic receipt server 80 as a destination. The e-mail server 500 transfers the stored e-mail data to the electronic receipt server 80 in response to an inquiry from the electronic receipt server 80. The e-mail server 500 may be a general server which processes e-mail data containing e-mail address designating other destinations.

Although only the commodity sales processing system associated with one retail store 100 is shown in FIG. 2, commodity sales processing systems having the same structure may be provided in a plurality of retail stores 100. In this case, the plurality of commodity sales processing systems is separately connected with the network 200. Moreover, the commodity sales processing systems may share the electronic receipt server 80.

[POS Apparatuses 10 and 20 (Commodity Sales Data Processing Apparatus)]

As shown in FIG. 1, the face-to-face POS apparatus 10 arranged along a checkout counter 2 at a settlement place 1 is operated by a cashier 3. The POS apparatus 10 includes a scanner 11 disposed on the checkout counter 2. The scanner 11 is also operated by the cashier 3. The cashier 3 faces, across the checkout counter 2, a customer 4 waiting in front of the checkout counter 2 for checkout. The cashier 3 reads, with the scanner 11, the barcode attached to a commodity 5 to be purchased by the customer 4. The scanner 11 sends barcode data obtained from the barcode to the POS apparatus 10. The POS apparatus 10 specifies the commodity 5 based on the barcode data sent from the scanner 11 and registers the sales quantity, the sales amount, and other sales information of the commodity 5 in a purchased commodity list. Further, the POS apparatus 10 displays the commodity name and the sales amount of the commodity 5 and the total amount of all the commodities included in the purchased commodity list, on displays 13a and 13b. The display 13a is for an operator. The display 13b is for a customer 4.

After the commodities 5 to be purchased by the customer 4 are all registered, the cashier 3 inputs payment data into the POS apparatus 10. For example, the cashier 3 operates a keyboard 12 to input an amount paid by the customer 4. The POS apparatus 10 settles the commodity transaction for the customer 4 according to the payment data. During the settlement process, the POS apparatus 10 drives a printer 14 to issue a receipt (hereinafter referred to as a paper receipt) by printing the details of the commodity transaction on a receipt paper. If the customer 4 is a user (subscriber) of the electronic receipt system, then the issuing of the paper receipt may be optional.

The self-service POS apparatus 20 is installed at a settlement place 1 for the customer 4 to operate. The POS apparatus 20 includes a scanner 21, a touch panel 22, an automatic change dispensing mechanism 23, and a printer 24 for issuing a receipt. The customer 4 standing in front of the POS apparatus 20 operates the scanner 21 to read the barcode attached to a commodity 5 purchased by the customer 4. The POS apparatus 20 specifies the commodity 5 according to the barcode read by the scanner 21 and registers the sales data of the commodity 5 in a purchased commodity list. Further, the POS apparatus 20 displays the commodity name and the sales amount of the commodity 5 and the total amount of all the commodities included in the purchased commodity list, on the touch panel 22.

After registering each commodity 5 to be purchased, the customer 4 inputs payment data into the POS apparatus 20. For example, the customer 4 operates the touch panel 22 to select a payment method. If cash payment is selected, the customer 4 puts cash into the automatic change dispensing mechanism 23. In this case, the automatic change dispensing mechanism 23 calculates a total amount of the input cashes and outputs the total amount as payment data. If electronic money payment is selected, the customer 4 holds an electronic money card over a reader/writer (not shown). The reader/writer reads electronic money data recorded on the electronic money card and outputs the data as payment data. The POS apparatus 20 settles the commodity transaction for the customer 4 according to the payment data. During the settlement process, the POS apparatus 20 drives the printer 24 to issue a paper receipt. If the customer 4 is a user (subscriber) of the electronic receipt system, then the issuing of the paper receipt may be optional.

The payment methods available in the POS apparatus 20 may include other methods such as credit card payment and voucher payment in addition to the foregoing methods. The payment methods available in the POS apparatus 10 may also include other methods such as credit card payment and voucher payment in addition to foregoing methods.

The POS apparatus 10 or 20 is referred to as a commodity sales data processing apparatus.

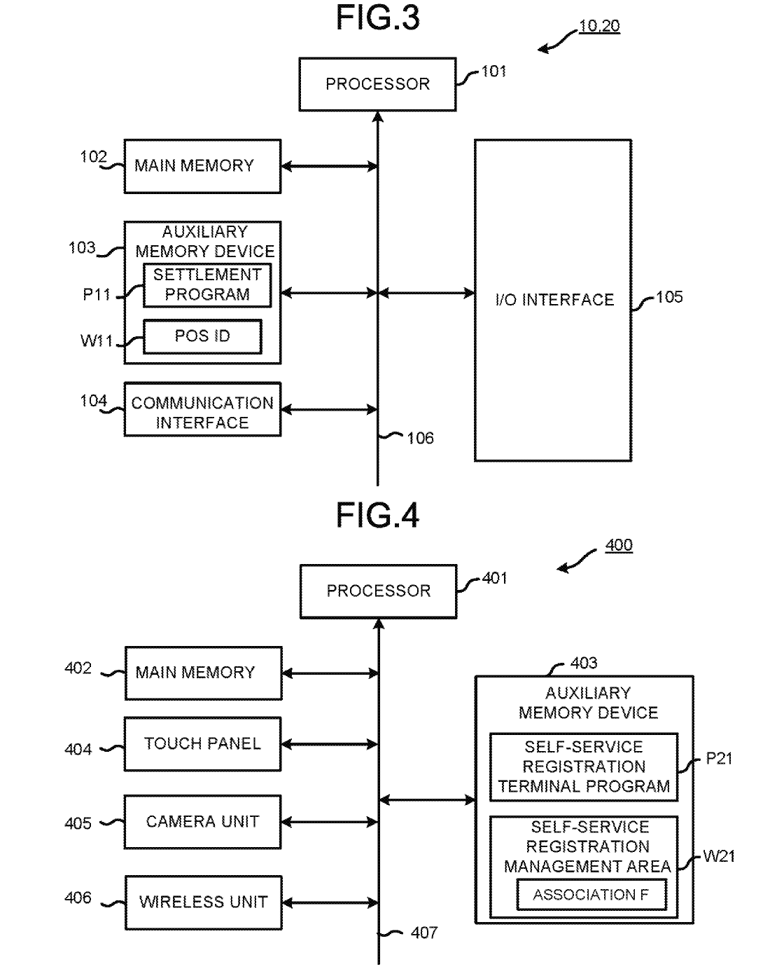

FIG. 3 is a block diagram of main portions of the POS apparatus 10 or 20.

The POS apparatus 10 or 20 includes a processor 101, a main memory 102, an auxiliary memory device 103, a communication interface 104 and an I/O (Input/Output) interface 105. The processor 101 is connected with the main memory 102, the auxiliary storage device 103, the communication interface 104, and the I/O interface 105 by a system transmission path 106 including an address bus line, a data bus line, a control signal line, and the like.

In the POS apparatus 10 or 20, the processor 101, the main memory 102, the auxiliary memory device 103, and the system transmission path 106 connecting these components work as a computer.

The processor 101 acts as the main unit of the computer. The processor 101 controls each section for performing various functions of the POS apparatus 10 or 20 according to an operating system and application programs.

The main memory 102 acts as main memory of the computer. The main memory 102 includes a nonvolatile memory unit and a volatile memory unit. The main memory 102 stores the operating system and the application programs in the nonvolatile memory unit. Further, in some cases, the main memory 102 also stores data needed by the processor 101 for controlling each section in the nonvolatile or volatile memory unit. The main memory 102 uses the volatile memory unit as a working area for the processor 101 to rewrite data properly. The volatile memory unit includes a memory region for storing the foregoing purchased commodity list, which is called as a registration processing region.

The auxiliary memory device 103 acts as an auxiliary storage unit of the computer. The auxiliary storage device 103 is, for example, an EEPROM (Electric Erasable Programmable Read-Only Memory), an HDD (Hard Disk Drive), or an SSD (Solid State Drive). The auxiliary memory device 103 persistently stores the data used by the processor 101 to carry out various processes and the data resulting from the process executed by the processor 101. The auxiliary memory device 103 stores the operating system and the application programs as well in some cases.

A settlement program P11 is included in the application programs stored in the auxiliary memory device 103. The settlement program P11 may also be downloaded from, for example, the Internet and written into the auxiliary memory device 103 according to an operation of the user of the POS apparatus 10 or 20. That is, the auxiliary memory device 103 of the portable information terminal 400 may not initially store the settlement program P11. The settlement programs P11 include a first type and a second type. The difference between the first and second types is as follows: according to the first type, generated receipt data are in a structured form; and according to the second type, generated receipt data are in an unstructured form and included in e-mail data. Further, the unstructured form is an example of a first form, and the electronic receipt data correspond to the first receipt data. Moreover, the structured form is an example of a second form, and the text of the e-mail data correspond to the second receipt data.

Apart of the memory area of the auxiliary memory device 103 is used for a POS ID storage region W11 which stores the specific POS IDs of the POS apparatuses 10 and 20. Alternatively, the POS IDs of the POS apparatuses 10 and 20 may also be stored in the nonvolatile area of the main memory 102. The store server 40 and the support server 50 identify each of the POS apparatuses 10 and 20 according to the POS ID thereof.

The communication interface 104 is an interface for the data communication between the store server 40 and the support server 50 which are connected with each other via the LAN 70.

The I/O interface 105 is an interface for the data communication among various input/output devices. In the POS apparatus 10, the scanner 11, the keyboard 12, the displays 13a and 13b, and the printer 14 are connected with the I/O interface 105. In the POS apparatus 20, the scanner 21, the touch panel 22, the automatic change dispensing mechanism 23, and the printer 24 are connected with the I/O interface 105.

The number of the POS apparatuses 10 or 20 disposed in a retail store 100 is not limited. A suitable number of POS apparatuses 10 and a suitable number of POS apparatuses 20 are arranged in the retail store 100 according to the scale or the internal layout of the retail store 100. Further, it is not necessary to arrange both of the POS apparatuses 10 and the POS apparatuses 20. Instead, only one of the POS apparatuses 10 and the POS apparatuses 20 may be arranged at the settlement place 1.

Each of the POS apparatuses 10 and 20 has a barcode 7 indicating the POS ID thereof. For example, as shown in FIG. 1, on the POS apparatus 10, a barcode 7 is placed on a side of the scanner 11 opposite to a side where the cashier 3 operates the scanner 11, that is, on the customer 4 side. In the POS apparatus 20, the barcode 7 is placed on the front side of the housing of the self-service POS apparatus 20 opposite to the customer 4. Further, the position of the barcode 7 shown in FIG. 1 is only exemplary, and the position of the barcode 7 is not limited. Moreover, the barcode 7 may be replaced by a two-dimensional data code (e.g., QR code).

[Store Server 40]

The store server 40 includes a commodity database 41 in which commodity data, for example, commodity name and price, of each commodity for sale in the retail store 100 is stored in association with the commodity code thereof. The commodity code of each commodity 5 is unique. The commodity code of the commodity 5 is contained in the barcode data represented by the barcode of the commodity 5.

The store server 40 collects, via the LAN 70, the sales data of each commodity 5 registered by the POS apparatus 10 or 20, including the commodity code and the purchase quantity thereof or payment data paid therefor. Moreover, the store server 40 sorts the collected sales data by commodity name or purchase time.

The store server 40 and the POS apparatus 10 or 20, as a whole, work as a POS system.

[Relay 30]

The relay 30 conforms to, for example, a wireless communication standard such as Wi-Fi (Wireless Fidelity). The relay 30 sends or receives data through wireless communication to enable the one or more portable information terminals 400 existing in a wireless communication region to access the LAN 70. The number of the relays 30 is not limited. A suitable number of relays 30 are disposed in the retail store 100 in consideration of the scale or the internal layout of the retail store 100 to provide a wireless communication region substantially covering the wholesales place 6 and the whole settlement place 1 inside the retail store 100.

[Portable Information Terminal 400]

FIG. 4 is a block diagram of main portions of the portable information terminal 400.

The portable information terminal 400 is a portable information processing apparatus such as a smart phone, a mobile phone, or a tablet terminal. The portable information terminal 400 includes a processor 401, a main memory 402, an auxiliary memory device 403, a touch panel 404, a camera unit 405, and a wireless unit 406. The processor 401 is connected with the main memory 402, the auxiliary memory device 403, the touch panel 404, the camera unit 405, and the wireless unit 406 by a system transmission path 407 including an address bus line, a data bus line, a control signal line, and the like.

In the portable information terminal 400, the processor 401, the main memory 402, the auxiliary memory device 403, and the system transmission path 407 connecting these components work as a computer.

The processor 401 acts as the main unit of the computer. The processor 401 controls each section for performing functions of the portable information terminal 400 according to an operating system and application programs.

The main memory 402 acts as main memory of the computer. The main memory 402 includes a nonvolatile memory unit and a volatile memory unit. The main memory 402 stores the operating system and the application programs in the nonvolatile memory unit. Further, in some cases, the main memory 402 also stores the data needed by the processor 401 for controlling each section in the nonvolatile or volatile memory unit. The main memory 402 uses the volatile memory unit as a working area for the processor 401 to rewrite data properly.

The auxiliary memory device 403 acts as an auxiliary memory unit of the computer. The auxiliary memory device 403 is, for example, an EEPROM. An HDD or SSD may also be used as the auxiliary memory device 403. The auxiliary memory device 403 persistently stores data used by the processor 401 to carry out various processes and data resulting from the process carried out by the processor 401. The auxiliary memory device 403 also stores the operating system and the application programs.

A self-service registration terminal program P21 is included in the application programs stored in the auxiliary memory device 403. Typically, the self-service registration terminal program P21 is downloaded from, for example, the Internet and written into the auxiliary memory device 403 according to an operation of the user of the portable information terminal 400. That is, the portable information terminal 400 does not originally contain the self-service registration terminal program P21 in the auxiliary memory device 403. Alternatively, the portable information terminal 400 may originally contain the self-service registration terminal program P21 stored in the auxiliary memory device 403.

The touch panel 404 functions as the input device and the display device of the portable information terminal 400. Icons for starting the application programs are displayed on the touch panel 404, through the execution of a process by the processor 401 based on the operating system.

The camera unit 405 generates image data corresponding to the image of a photographed object. The camera unit 405 is able to capture a barcode image of the commodity 5 having a resolution sufficient for recognition of the barcode.

The wireless unit 406 sends or receives data between the relay 30 and the network 200 through wireless communication.

With execution of a process by the processor 401 based on the self-service registration terminal program P21, the portable information terminal 400 having the foregoing structure functions as a self-service registration terminal. When a process based on the self-service registration terminal program P21 is performed, the processor 401 uses a part of the memory region of the auxiliary memory device 403 as a self-service registration management region W21.

[Support Server 50]

FIG. 5 is a block diagram of main portions of the support server 50.

The support server 50 includes a processor 501, a main memory 502, an auxiliary memory device 503, and a communication interface 504. The processor 501 is connected with the main memory 502, the auxiliary memory device 503, and the communication interface 504 by a system transmission path 505 including an address bus line, a data bus line, a control signal line, and the like.

In the support server 50, the processor 501, the main memory 502, the auxiliary memory device 503, and the system transmission path 505 connecting these components work as a computer.

The processor 501 acts as the main unit of the computer. The processor 501 controls each section for performing various functions of the support server 50 according to an operating system and application programs.

The main memory 502 acts as main memory of the computer. The main memory 502 includes a nonvolatile memory unit and a volatile memory unit. The main memory 502 stores the operating system and the application programs in the nonvolatile memory unit. Further, in some cases, the main memory 502 also stores the data needed by the processor 501 to carry out a process for controlling each section, in the nonvolatile or volatile memory unit. The main memory 502 uses the volatile memory unit as a working area for the processor 501 to rewrite data properly.

The auxiliary memory device 503 acts as an auxiliary memory region of the computer. The auxiliary memory device 503 is, for example, an EEPROM, an HDD, or an SSD. The auxiliary memory device 503 persistently stores data used by the processor 501 to carry out various processes and data resulting from the process carried out by the processor 501. The auxiliary memory device 503 stores the foregoing operating system and application programs as well in some cases. A self-service registration server program P31 is included in the application programs stored in the auxiliary memory device 503.

The communication interface 504 is an interface for the data communication between the store server 40 and each POS apparatus 10 or 20 via the LAN 70.

The support server 50 employs, for example, a general server or computer as a basic hardware thereof. To achieve the support server 50, a server or computer having no self-service registration server program P31 in the auxiliary memory 503 and the self-service registration server program P31 may be separately provided to the user. In this case, the self-service registration server program P31 may be delivered by being recorded in a moveable recording medium such as a magnetic disc, a magneto-optical disc, a compact disc, and a semiconductor memory or by being downloaded through a network. In this case, the self-service registration server program P31 may be written into the auxiliary memory device 503 according to an operation of the user.

When providing a service through the self-service registration system, the processor 501 repeatedly carries out a process in accordance with the self-service registration server program P31. The customer 4 can carry out self-service registration through a process carried out by the processor 501 and the process carried out by the processor 401 of the portable information terminal 400 in accordance with the self-service registration terminal program P21.

To carry out the process in accordance with the self-service registration server program P31, the processor 501 uses apart of the memory region of the auxiliary memory device 503 as a store information region W31, a transaction file region W32, and a self-service registration ID list region W33.

The store information region W31 stores information relating to the retail store 100 having the support server 50. The information stored in the store information region W31 includes, for example, name of the store.

The transaction file region W32 stores a commodity transaction file (described below).

The self-service registration ID list region W33 stores a list of self-service registration IDs for identifying customers 4 who use the self-service registration system.

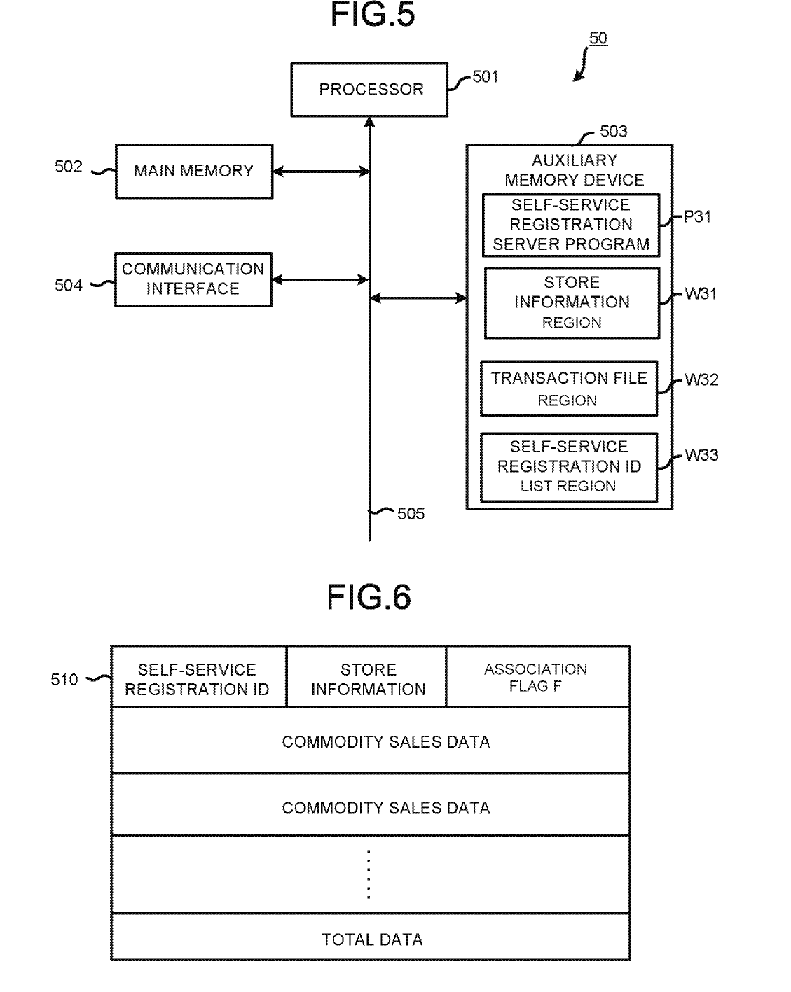

FIG. 6 illustrates data structure of a commodity transaction file 510.

The commodity transaction file 510 consists of a self-service registration ID, store information, an association flag F, one or more commodity sales data, and total data. A plurality of commodity transaction files 510 respectively corresponding to a plurality of customers 4 can be stored in the transaction file region W32 at the same time.

The self-service registration ID is a unique code of a customer 4 who uses the self-service registration.

The association flag F is 1-bit information indicating whether or not the self-service registration system cooperates with the electronic receipt system. In a case of association, the association flag F is set to, for example, ‘1’. In a case of no association, the association flag F is set to, for example, ‘0’.

The commodity sales data are a set of data relating to a commodity for which a self-service registration is executed. The commodity sales data include a commodity code, a commodity name, a unit price, quantity, and a price total.

[Electronic Receipt Server 80]

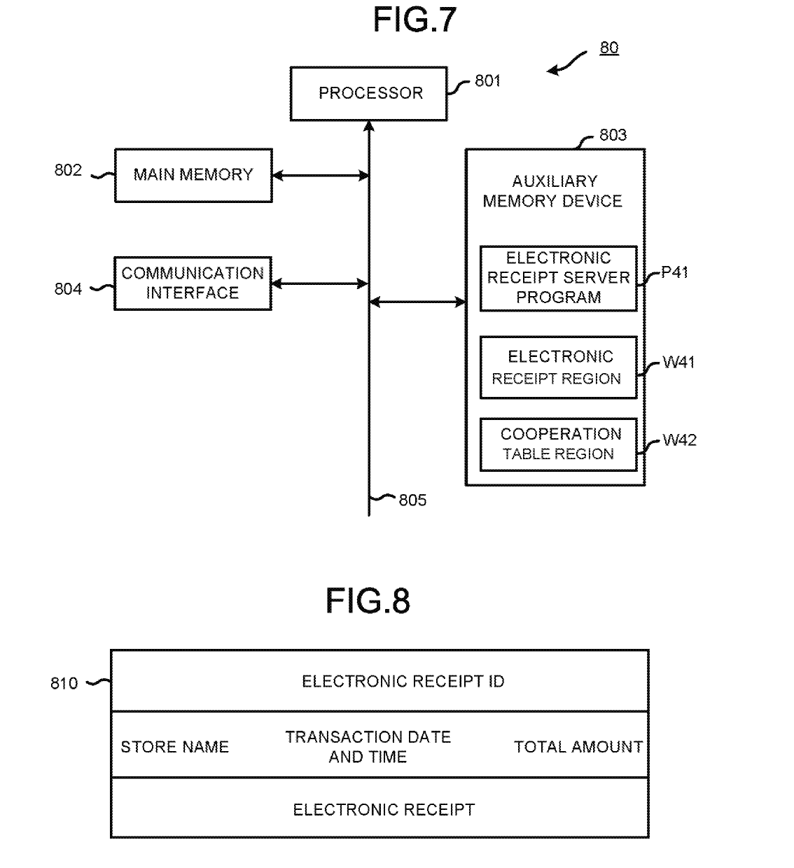

FIG. 7 is a block diagram of main portions of the electronic receipt server 80.

The electronic receipt server 80 includes a processor 801, a main memory 802, an auxiliary memory device 803, and a communication interface 804. The processor 801 is connected with the main memory 802, the auxiliary memory device 803, and the communication interface 804 by a system transmission path 805 including an address bus line, a data bus line, a control signal line, and the like.

In the electronic receipt server 80, the processor 801, the main memory 802, the auxiliary memory device 803, and a system transmission path 805 connecting these components work as a computer.

The processor 801 acts as the main unit of the computer. The processor 801 controls each section for performing various functions of the electronic receipt server 80 according to an operating system and application programs.

The main memory 802 acts as main memory of the computer. The main memory 802 includes a nonvolatile memory unit and a volatile memory unit. The main memory 802 stores the operating system and the application programs in the nonvolatile memory unit. Further, in some cases, the main memory 802 also stores the data needed by the processor 801 for controlling each section in the nonvolatile or volatile memory unit. The main memory 802 uses the volatile memory unit as a working area for the processor 801 to rewrite data properly.

The auxiliary memory device 803 acts as auxiliary memory of the computer. The auxiliary memory device 803 is, for example, an EEPROM, an HDD, or an SSD. The auxiliary memory device 803 persistently stores data used by the processor 801 to carry out various processes and data resulting from the process carried out by the processor 801. The auxiliary memory device 803 stores the operating system and the application programs. An electronic receipt server program P41 is included in the application programs stored in the auxiliary memory device 803.

The communication interface 804 is an interface for data communication with another computer via the network 200.

The electronic receipt server 80 can be set up using, for example, a general server or computer as a basic hardware thereof. To achieve the electronic receipt server 80, a server or computer having no electronic receipt server program P41 in the auxiliary memory device 803 and the electronic receipt server program P41 may be separately provided to the user. In this case, the electronic receipt server program P41 can be delivered by being recorded in a moveable recording medium such as a magnetic disc, a magneto-optical disc, a compact disc, and a semiconductor memory or by being downloaded through a network. In this case, the electronic receipt server program P41 may be written into the auxiliary memory device 503 according to an operation of the user.

When providing a service based on the electronic receipt system, the processor 801 repeatedly carries out a process in accordance with the electronic receipt server program P41. The customer 4 can use electronic receipt view service through a process carried out by the processor 801 in accordance with the electronic receipt server program P41 and the process carried out by the processor 401 of the portable information terminal 400 in accordance with the self-service registration terminal program P21.

To carry out the process in accordance with the electronic receipt server program P41, the processor 801 uses a part of the memory region of the auxiliary memory device 803 as an electronic receipt region W41 and an association table region W42.

An electronic receipt file is stored in the electronic receipt region W41.

FIG. 8 is a diagram illustrating the data structure of an electronic receipt file 810.

The electronic receipt file 810 consists of an electronic receipt ID, simplified data of an electronic receipt made up of a store name, a transaction date and time and a total amount and actual data of the electronic receipt. A plurality of electronic receipt files 810 respectively corresponding to a plurality of commodity transactions can be stored in the electronic receipt region W41 at the same time.

The electronic receipt ID is a unique code for identifying a customer 4 using the electronic receipt system.

The electronic receipt ID is an example of a user code. Moreover, the auxiliary memory device 803 is an example of a memory device which stores electronic receipt data in association with a user code.

An association table is stored in the association table region W42.

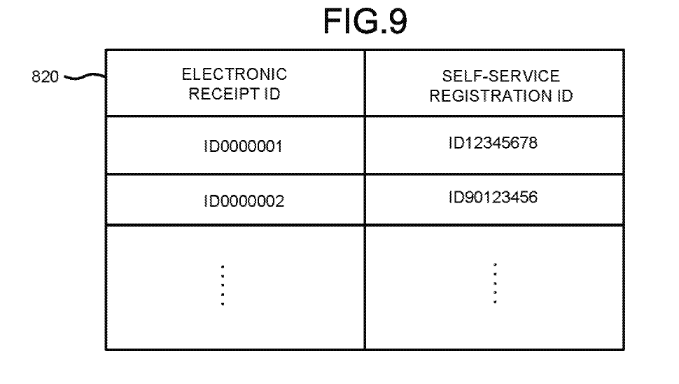

FIG. 9 illustrates a data structure of an association table 820.

The association table 820 stores the electronic receipt ID of a customer 4 who uses the electronic receipt system and a self-service registration ID of the customer 4 who uses the self-service registration, in association with each other.

[Operations of Commodity Sales Data Processing System]

Next, an operation of the commodity sales data processing system will be described. Additionally, the content of each process described below is merely an example, and various other processes that can achieve the same effect are also adequately applicable.

A customer 4 who wants to use the self-service registration system installs the self-service registration terminal program P21 in a portable information terminal 400. Sequentially, the customer 4 brings the portable information terminal 400 in which processor 401 executes the self-service registration terminal program P21 in the retail store 100. The processor 401 starts a process based on the self-service registration terminal program P21 according to a specific operation performed by the customer 4 on a touch panel.

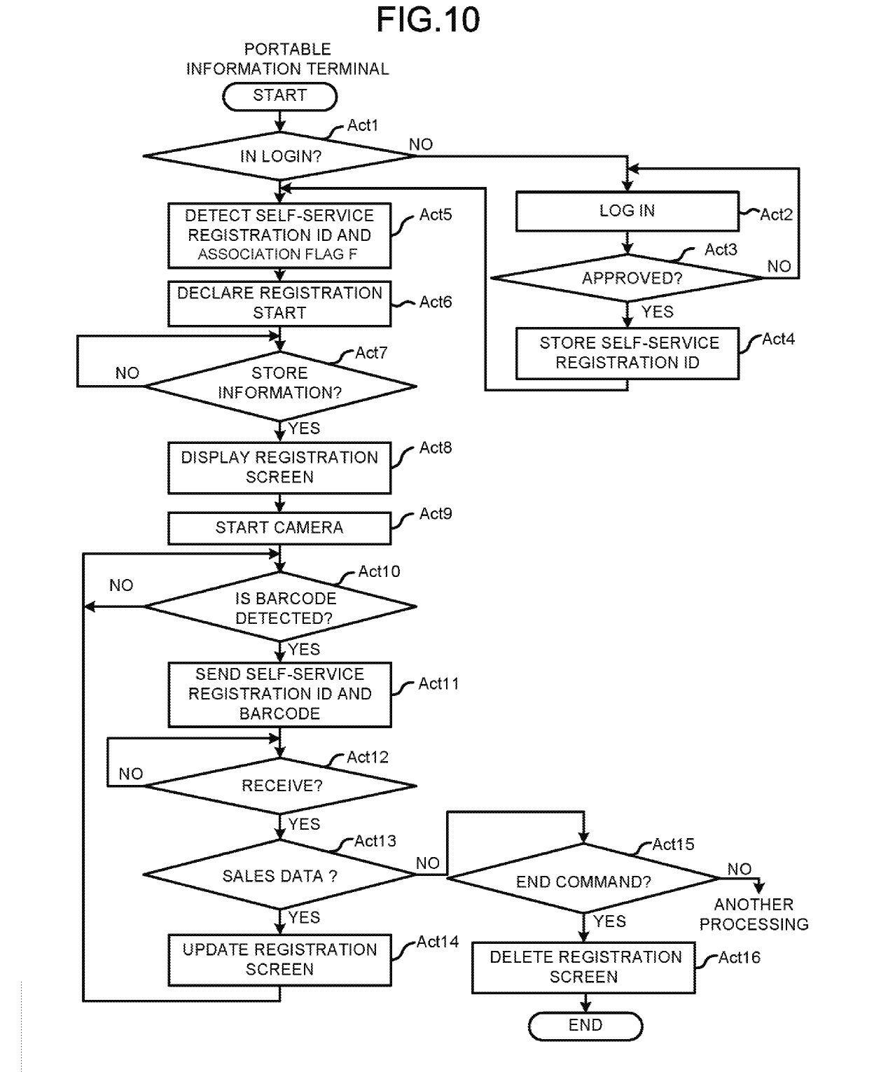

FIG. 10 is a flowchart illustrating a process carried out by the processor 401 based on the self-service registration terminal program P21.

In Act 1, the processor 401 determines whether or not the customer 4 logged into the support server 50 through the portable information terminal 400. Specifically, the processor 401 first determines whether or not the wireless unit 406 can communicate according to a wireless communication standard conforming to the relay 30. Then, the processor 401 tries to access the support server 50 if the wireless unit 406 can communicate. If the wireless communication standard is a general standard such as Wi-Fi, the wireless unit 406 can communicate even when the portable information terminal 400 is located in the wireless communication region of a wireless communication unit other than the relay 30. However, in this case, the processor 401 cannot directly access the support server 50. The processor 401 can access the support server 50 via the relay 30 and the LAN 70 when the portable information terminal 400 can communicate with the relay 30 via the wireless unit 406 after entering the wireless communication region of the relay 30. Moreover, if it is possible to access the support server 50, the processor 401 inquires the support server 50 of whether or not the customer 4 has logged in the support server 50. The result of the determination of Act 1 is ‘No’ if the customer 4 has not logged in the support server 50, then the processor 401 proceeds to carry out Act 2.

In Act 2, the processor 401 carries out a login process. Specifically, the processor 401 displays a login screen on the touch panel 404. The login screen is a screen for the customer 4 to input a self-service registration ID. In addition to the self-service registration ID, the customer 4 may also input a password on the login screen. If the customer 4 inputs required information by operating the touch panel 404, the processor 401 sends a login request command containing the input information to the support server 50.

Here, the self-service registration ID is a unique code for identifying the customer 4 executing a self-service registration process. The self-service registration ID which is set by, for example, the customer 4 optionally, is different from that set by another customer 4. However, the self-service registration ID which is different from that set by another customer 4 may also be automatically set by the processor 501.

The processor 401 displays a setting screen (not shown) on the touch panel 404 when, for example, the touch of the customer 4 on a new registration button displayed on the login screen is detected by the touch panel 404. The setting screen is a screen for the customer 4 to input a self-service registration ID the customer 4 wants to set. When a password is needed for login, the setting screen is a screen for the customer 4 to input the password and a self-service registration ID. Further, the setting screen is a screen for the customer 4 to input an e-mail address, as a notification destination of a receipt by e-mail, as needed.

If the customer 4 inputs required information by operating the touch panel 404, the processor 401 sends a registration request command containing the input information to the support server 50. In the support server 50, the processor 501 stores the self-service registration ID contained in the registration request command in the self-service registration ID list region W33 if the self-service registration ID is different from those already stored in the self-service registration ID list region W33. Further, if a password is contained in the registration request command, the processor 501 stores the password in the self-service registration ID list regionW33 in association with the self-service registration ID. If an e-mail address is contained in the registration request command, the processor 501 stores also the e-mail address in the self-service registration ID list region W33 in association with the self-service registration ID. In this way, the processor 501 creates a list of self-service registration IDs of customers 4 in the self-service registration ID list region W33.

Moreover, if the login request command is received, the processor 501 determines whether or not the currently-shown self-service registration ID is stored in the list of self-service registration IDs stored in the self-service registration ID list region W33. If the password is authenticated, the processor 501 determines whether or not the combination of the self-service registration ID and the password contained in the login request command is the same as the combination of a self-service registration ID and a password contained in the list of self-service registration IDs. Then, the processor 501 determines whether or not to approve the login according to the results of the determination and notifies the portable information terminal 400 from which login information is sent of the result of the determination as an authentication result.

Moreover, a session is established between the portable information terminal 400 from which login information is sent and the support server 50 if the processor 501 approves the login. The sending or receiving of data between the portable information terminal 400 and the support server 50 is described below and carried out for the session.

In Act 3, the processor 401 determines whether or not the login is approved according to the result of the authentication. If it is determined that the login is not approved (Act 3: No), the processor 401 returns to carry out Act 2. In this way, the processor 401 requests the portable information terminal 400 to log into the support server 50 in Acts 2 and 3 every time login information is input.

If it is determined that the login is approved (Act 3: Yes), the processor 401 proceeds to carry out Act 4.

In Act 4, the processor 401 stores the self-service registration ID contained in the approved login request command in the self-service registration management region W21. Then, the processor 401 carries out Act 5. Further, if the login is approved, the processor 501 may further determine a specific session ID and include the session ID in the authentication result. In this case, the processor 401 may store the session ID contained in the authentication result, instead of the self-service registration ID, in the self-service registration management region W21.

Here, the support server 50 basically maintains the login state only if it is not requested to log out from the portable information terminal 400 in a login state. That is, the login state of the portable information terminal 400 is maintained even if the processor 401 has not accessed the support server 50 for a long time. This situation occurs if, for example, the processor 401 ends the process while not logging out during the former execution of the self-service registration terminal program P21. Alternatively, this situation may occur if the portable information terminal 400 in a logged-in state exits from the wireless communication region of the relay 30.

Thus, if the portable information terminal 400 has already logged into the support server 50, the processor 401 determines the result of the determination of Act 1 to be ‘Yes’ and then proceeds to carry out Act 5 without carrying out Act 2-Act 4.

In Act 5, the processor 401 searches the self-service registration ID and an association flag F from the self-service registration management region W21. The association flag F is set through a separate setting process (not shown) executed by the processor 401 according to an operation of the customer 4. The processor 401 initially sets the association flag F to ‘0’. The processor 401 sets the association flag F to ‘1’ if the customer 4 performs a specific operation on the touch panel 404 to set the association of the self-service registration system with the electronic receipt system and to ‘0’ if the customer 4 performs a specific operation on the touch panel 404 to set no association of the self-service registration system with the electronic receipt system.

Further, a customer 4 who desires the association of the self-service registration system with the electronic receipt system registers oneself in advance to use the electronic receipt system. A specific electronic receipt ID is set for the customer 4 during the registration process. The electronic receipt ID may be determined by the electronic receipt system or the user of the electronic receipt system or optionally be designated by the customer 4. Although the electronic receipt ID is set to be different from the self-service registration ID of the customer 4 in the present embodiment, the electronic receipt ID may also be identical to the self-service registration ID of the customer 4. The customer 4 further carries out an association process to associate the self-service registration ID with the electronic receipt ID. The registration process and the association process may be carried out as a series of processes or separately carried out at different timing. According to the association process, in the electronic receipt server 80, the self-service registration ID and the electronic receipt ID are added in the association table region W42 of the auxiliary memory device 803 in an associated manner.

In Act 6, the processor 401 wirelessly sends a registration start command from the wireless unit 406 to the support server 50. The registration start command contains the self-service registration ID and the association flag F detected in Act 5. The registration start command is received by the relay 30 and transmitted to the support server 50 via the LAN 70.

When the support server 50 is in a normal operational state, the processor 501 carries out a process based on the self-service registration server program P31.

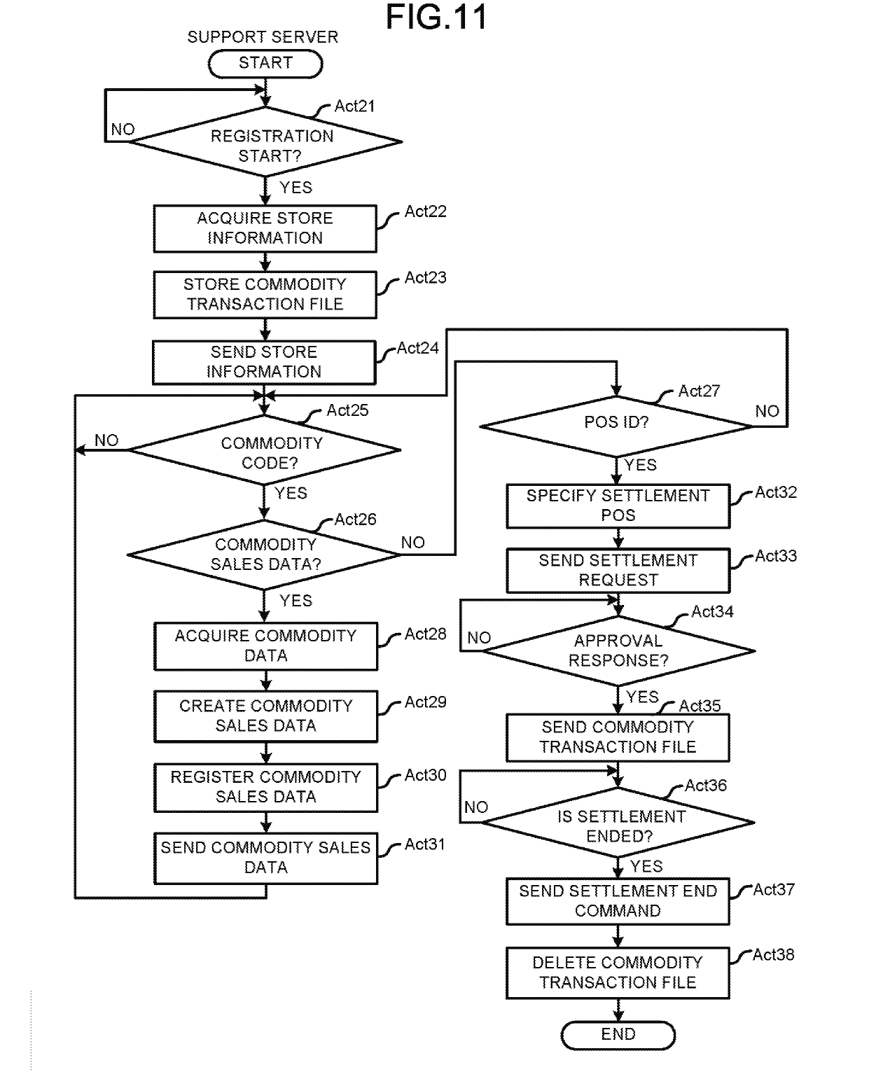

FIG. 11 is a flowchart illustrating a process carried out by the processor 501 based on the self-service registration server program P31.

In Act 21, the processor 501 determines whether or not a registration start command is received. The registration start command sent from the portable information terminal 400, if transferred to the support server 50 via the LAN 70 described, is received by the communication interface 504. The communication interface 504 writes the registration start command into the main memory 502 and notifies the processor 501 that the registration start command is written in the main memory 502. The processor 501 repeatedly carries out Act 21 if the result of the determination of Act 21 is ‘No’ during the period of no notification. That is, the processor 501 waits to receive a registration start command in Act 21. If the notice is received, then processor 501 determines that the result of the determination of Act 21 is ‘Yes’ and consequentially proceeds to carry out Act 22.

In Act 22, the processor 501 acquires store information from the store information region W31 of the auxiliary memory device 503.

In Act 23, the processor 501 generates a new commodity transaction file and stores the generated commodity transaction file in the transaction file region W32. The processor 501 generates the new commodity transaction file 510, which includes the self-service registration ID and the association flag F contained in the registration start command and the store information acquired in Act 22 and does not include commodity sales data.

In Act 24, the processor 501 sends the store information acquired in Act 22 from the communication interface 504 through the LAN 70 to the portable information terminal 400 which sends the registration start command.

Further, in the portable information terminal 400, the processor 401 proceeds to carry out Act 7 after sending the registration start command in Act 6.

In Act 7, the processor 401 determines whether or not the store information is received. If the store information sent from the support server 50 is transmitted to the portable information terminal 400 via the LAN 70 and the relay 30, as described above, the store information is received by the wireless unit 406. The wireless unit 406 writes the store information into the main memory 402 and notifies the processor 401 that the store information is written in the main memory 402. The processor 401 determines that the result of the determination of Act 7 is ‘No’ if there is no notice and repeatedly carries out Act 7. That is, the processor 401 waits to receive store information in Act 7. If the notice is received, then the result of the determination of Act 7 is ‘Yes’, consequentially, the processor 401 proceeds to carry out Act 8.

In Act 8, the processor 401 displays a registration screen on the touch panel 404. The registration screen includes display columns for a commodity name, a price, and a total amount. Further, content of the store information written in the main memory 402 by the wireless unit 406 in the foregoing way is displayed on the registration screen.

In Act 9, the processor 401 starts the camera unit 405.

The customer 4, after reviewing the registration screen, starts a commodity registration process in the sales place 6. That is, the customer 4 holds a commodity 5 purchased by himself/herself over the portable information terminal 400 in such a manner that the barcode of the commodity 5 is located in the field of view of the camera unit 405. In this way, the barcode of the commodity 5 is included in an image represented by the image data generated by the camera unit 405.

In Act 10, the processor 401 analyzes the image data generated by the camera unit 405 to detect a barcode. The result of the detection of Act 10 is ‘No’ if no barcode is included in the image represented by the image data corresponding to a frame generated by the camera unit 405, and then the processor 401 repeatedly carries out Act 10. The result of the detection of Act 10 is ‘Yes’ if a barcode is included in the image, and then the processor 401 proceeds to Act 11.

In Act 11, the processor 401 wirelessly sends the barcode data represented by the barcode, together with the self-service registration ID, to the support server 50. Specifically, the processor 401 analyzes the image data and obtains barcode data represented by the barcode. Further, the processor 401 reads out the self-service registration ID stored in the self-service registration management region W21. Then, the processor 401 sends transfer data containing the barcode data and the self-service registration ID to the wireless unit 406, such that the transfer data are sent to the support server 50. The transfer data is transferred to the support server 50 via the relay 30 and the LAN 70.

Further, in the support server 50, the processor 501 proceeds to carry out Act 25 after sending the store information in Act 24 shown in FIG. 11.

In Act 25, the processor 501 determines whether or not a barcode is received. If the transfer data sent from the portable information terminal 400 are transmitted to the support server 50 via the relay 30 and the LAN 70, the transfer data are received by the communication interface 504. The communication interface 504 writes the barcode data and the self-service registration ID contained in the transfer data into the main memory 502 and notifies the processor 501 that the barcode data and the self-service registration ID are written in the main memory 502. If there is no notice, the processor 501 determines that the result of the determination of Act 25 is ‘No’ and therefore repeatedly carries out Act 25. That is, the processor 501 waits to receive a barcode in Act 25. If the notice is received, then processor 501 determines that the result of the determination of Act 25 is ‘Yes’ and consequentially proceeds to carry out Act 26.

In Act 26, the processor 501 determines whether or not the received barcode data represents a commodity code. The result of the determination of Act 26 is ‘No’ if the received barcode data does not represent a commodity code. In this case, the processor 501 proceeds to carry out Act 27.

In Act 27, the processor 501 determines whether or not the received barcode data represents a POS ID. Barcode data representing a POS ID is different in the code system from barcode data representing a commodity code. The processor 501 determines the type of the barcode according to the difference in the code system. The result of the determination of Act 27 is ‘No’ if the received barcode data does not represent a POS ID. In this case, the processor 501 returns to carry out Act 25.

In this way, if the received barcode data does not represent either of a commodity code and a POS ID, the processor 501 deletes the received barcode data and enters await state to wait to receive next barcode data. The result of the determination of Act 26 is ‘Yes’ if the received barcode data represents a commodity code, in this case, the processor 501 proceeds to carry out Act 28.

In Act 28, the processor 501 acquires the commodity data of a commodity identified according to the commodity code represented by the barcode data. Specifically, the processor 501 sends a request command containing the commodity code to the store server 40 from the communication interface 504 through the LAN 70. The request command is transmitted to the store server 40 via the LAN 70. In this way, the store server 40 acquires, from the commodity database 41, commodity data associated with the commodity code contained in the request command. The store server 40 sends the acquired commodity data through the LAN 70 to the support server 50. The commodity data are transmitted to the support server 50 via the LAN 70. If the commodity data are transmitted to the support server 50, the commodity data are received by the communication interface 504. The communication interface 504 writes the commodity data into the main memory 502 and notifies the processor 501 that the commodity data are written in the main memory 502.

In Act 29, the processor 501 creates, according to the commodity data acquired in Act 28, commodity sales data containing a commodity code, a commodity name, a unit price, sales quantity, and a sales amount.

In Act 30, the processor 501 registers the created commodity sales data in the commodity transaction file 510. Specifically, the processor 501 updates the one of the commodity transaction files 510 stored in the transaction file region W32 in which the self-service registration ID received in synchronization with the barcode data is set to contain the commodity sales data created in Act 29.

In Act 31, the processor 501 sends the commodity sales data created in Act 29 from the communication interface 504 to the LAN 70, with the goal of sending the commodity sales data to the portable information terminal 400. Sequentially, the processor 501 returns to the wait state of Act 25.

Further, in the portable information terminal 400, the processor 401 proceeds to carry out Act 12 after sending the self-service registration ID and the barcode in Act 11.

In Act 12, the processor 401 determines whether or not any data sent from the support server 50 are received. If any data sent from the support server 50 are transmitted to the portable information terminal 400 via the LAN 70 and the relay 30, then the store information is received by the wireless unit 406. The wireless unit 406 writes the received data into the main memory 402 and notifies the processor 401 that the received data are written in the main memory 402. The processor 401 determines that the result of the determination of Act 12 is ‘No’ if there is no notice and then repeatedly carries out Act 12. That is, the processor 401 waits to receive any data sent from the support server 50 in Act 12. If the notice is received, then the processor 401 determines that the result of the determination of Act 12 is ‘Yes’ and proceeds to carry out Act 13.

In Act 13, the processor 401 determines whether or not the received data is commodity sales data. If the received data is commodity sales data, the processor 401 determines that the result of the determination of Act 13 is ‘Yes’ and consequentially proceeds to carry out Act 14.

In Act 14, the processor 401 updates the registration screen to display the commodity name and the price contained in the received commodity sales data. Specifically, the processor 401 additionally displays character strings indicating the commodity name and the price contained in the received commodity sales data in the display columns for a commodity name and a price included in the registration screen currently displayed on the touch panel 404. Further, if character strings are already displayed in each display column, the processor 401 replaces the displayed character strings with character strings indicating the commodity name and the price contained in the received commodity sales data.

The customer 4 checks the commodity name and the price displayed on the registration screen and places the commodity 5 of which barcode is photographed by the camera unit 405 in a shopping cart or shopping basket. Here, the shopping cart or shopping basket is an actual shopping cart or shopping basket but not a virtual one for online shopping. Apparently, the customer 4 may hold the commodity 5 directly by hands.

Sequentially, the processor 401 returns to the wait state of Act 10. In this way, the processor 401 of the portable information terminal 400 carries out the process in Act 10-Act 14 every time the camera unit 405 photographs the barcode attached to a commodity 5. On the other hand, the support server 50 carries out the process in Act 25-Act 31. As a result, the sales data of the commodity 5 purchased by the customer 4 are stored in the commodity transaction file 510 generated in Act 23. The set of commodity data stored in this way forms a purchased commodity list.

After registering each commodity 5 purchased by himself/herself, the customer 4 carries these registered commodities 5 to the settlement place 1 to make payment for these registered commodities 5. The customer 4 keeps the portable information terminal 400 in a state in which the processor 401 carries out the process shown in FIG. 10. In this case, the processor 401 is in the wait state of Act 10.

The settlement based on the commodity transaction file 510 created through the foregoing self-service registration may be executed by either of the POS apparatuses 10 and 20. If the settlement is executed by the POS apparatus 10, the customer 4 holds the portable information terminal 400 over the apparatus 10 in such a manner that the barcode 7 marked on the scanner 11 located on the checkout counter 2 is located inside the field of view of the camera unit 405. If the settlement is executed by the POS apparatus 20, the customer 4 holds the portable information terminal 400 over the POS apparatus 20 in such a manner that the barcode 7 marked on the housing of the POS apparatus 20 is located inside the field of view of the camera unit 405. In this way, the barcode 7 marked on the scanner 11 or the POS apparatus 20 is included in an image represented by the image data generated by the camera unit 405.

By including the barcode 7 in the image, the processor 401 determines that the result of the determination of Act 10 is ‘Yes’ and carries out Acts 11 and 12 sequentially as described above to proceed to Act 13. In this case, in the support server 50, the processor 501 determines that the result of the determination of Act 25 shown in FIG. 11 is ‘Yes’ and consequentially proceeds to carry out Act 26. The barcode data represented by the barcode 7 contains a POS ID but contains no commodity code. Thus, the processor 501 determines that the result of the determination of Act 26 is ‘No’ and consequentially proceeds to carry out Act 27. Then, the processor 501 determines that the result of the determination of Act 27 is ‘Yes’ and consequentially proceeds to carry out Act 32.

In Act 32, the processor 501 specifies one of the POS apparatuses 10 and 20 identified according to the POS ID as a POS apparatus designated by the customer 4 for settlement (hereinafter referred to as a designated POS apparatus). For example, the processor 501 inquires of each of the POS apparatuses 10 and 20 about the POS ID thereof via the LAN 70. Moreover, the processor 501 specifies the one of the POS apparatuses 10 and 20 which responds with a POS ID identical to the POS ID contained in the barcode data as a designated POS apparatus. Alternatively, a data table indicating a list of POS IDs of the POS apparatuses 10 and 20 is stored in the auxiliary memory device 503 in advance. The network address of each of the POS apparatuses 10 and 20 on the LAN 70 is stored in the data table in association with a POS ID in advance. Moreover, the processor 501 specifies the network address, associated with the POS ID contained in the barcode data, which is stored in the data table as the network address of the designated POS apparatus.

In Act 33, the processor 501 sends a settlement request command to the designated POS apparatus. The settlement request command is received by the relay 30 and transmitted to the designated POS apparatus via the LAN 70. If the settlement request command is sent to the designated POS apparatus via the LAN 70, the settlement request command is received by the communication interface 104 of the designated POS apparatus 10 or 20. The communication interface 104 notifies the processor 101 that the settlement request command is received.

If the POS apparatus 10 or 20 is in a normal operational state, the processor 101 carries out a sales data process similar to that carried out by another existing POS apparatus. Moreover, the processor 101 starts a process based on the settlement program P11 according to the generation of the notice from the communication interface 104. For example, the processor 101 carries out the two processes in parallel as two different jobs.

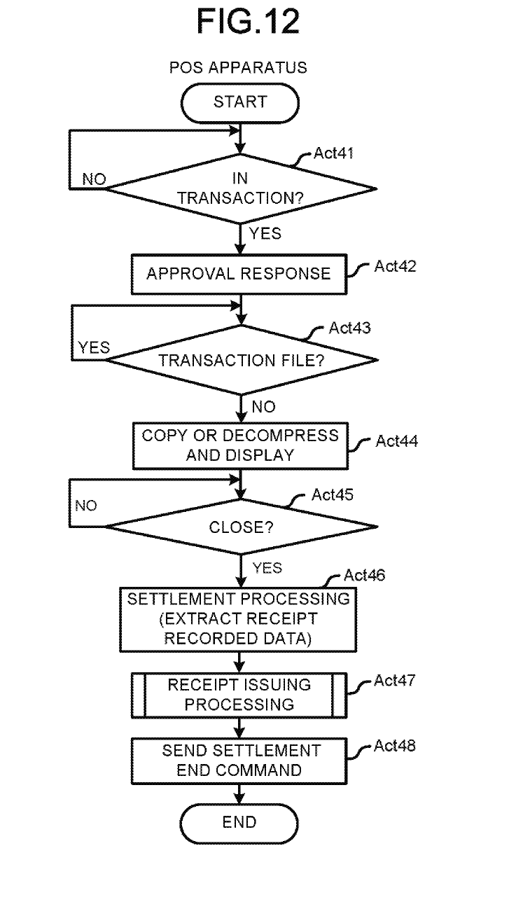

FIG. 12 is a flowchart illustrating a process carried out by the processor 101 based on the settlement program P11.

In Act 41, the processor 101 determines whether or not a commodity transaction based on a sales data process is being carried out. The barcode 7 is printed on, for example, an adhesive pasteboard which is adhered on each of the POS apparatuses 10 and 20. Thus, a barcode 7 can be photographed by the camera unit 405 of the portable information terminal 400 regardless of the operational state the POS apparatus 10 or 20. Thus, if a commodity transaction is ongoing, the processor 101 determines that the result of the determination of Act 41 is ‘No’ and repeatedly carries out Act 41. In this way, the processor 101 waits to enter a state in which no commodity transaction is being carried out. If a commodity transaction based on a sales data process is not being carried out, the processor 101 determines that the result of the determination of Act 41 is ‘Yes’ and consequentially proceeds to carry out Act 42.

In Act 42, the processor 101 returns an approval response to the support server 50. The approval response is transmitted to the support server 50 via the LAN 70.

Further, in the support server 50, the processor 501 proceeds to carry out Act 34 after sending the settlement request in Act 33 shown in FIG. 11.

In Act 34, the processor 501 determines whether or not an approval response is received. As described above, if the approval response sent from the designated POS apparatus is transmitted to the support server 50 via the LAN 70, then the communication interface 504 receives the approval response and notifies the processor 501 that the approval response is received. The processor 501 determines that the result of the determination of Act 34 is ‘No’ if there is no notice and consequentially repeatedly carries out Act 34. That is, the processor 501 waits to receive an approval response in Act 34. If the notice is received, then processor 501 determines that the result of the determination of Act 34 is ‘Yes’ and consequentially proceeds to carry out Act 35.

In Act 35, the processor 501 reads out a commodity transaction file 510 from the transaction file region W32 as a settlement processing object and sends the commodity transaction file 510 from the communication interface 504 to the LAN 70 with the goal of sending the commodity transaction file 510 to the designated POS apparatus. Specifically, the processor 501 takes the one of the commodity transaction files 510 stored in the transaction file region W32 in which the self-service registration ID received in synchronization with the barcode data representing a POS ID is stored as a settlement processing object. The commodity transaction file 510 is transmitted to the designated POS apparatus via the LAN 70. Further, if the self-service registration ID received in synchronization with the barcode data representing a POS ID is associated with an e-mail address in the list of self-service registration IDs of customers, the processor 501 appends the e-mail address to the commodity transaction file 510 and then sends the commodity transaction file 510.

Further, in the designated POS apparatus, the processor 101 proceeds to carry out Act 43 after sending an approval response in Act 42 shown in FIG. 12.

In Act 43, the processor 101 determines whether or not a commodity transaction file 510 is received. As described above, if the commodity transaction file 510 sent from the support server 50 is transmitted to the designated POS apparatus via the LAN 70, the commodity transaction file 510 is received by the communication interface 104. The communication interface 104 writes the commodity transaction file 510 into the main memory 102 and notifies the processor 101 that the commodity transaction file 510 is written in the main memory 102. If an e-mail address is appended to the commodity transaction file 510, then the communication interface 104 also writes the e-mail address into the main memory 102. The processor 101 determines that the result of the determination of Act 43 is ‘No’ if there is no notice and consequentially carries out Act 43 repeatedly. That is, the processor 101 waits to receive a commodity transaction file 510 in Act 43. If the notice is received, then processor 101 determines that the result of the determination of Act 43 is ‘Yes’ and consequentially proceeds to carry out Act 44.

In Act 44, the processor 101 copies or decompresses the commodity sales data contained in the commodity transaction file 510 stored in the main memory 102 to the registration processing area of the main memory 102. Further, the processor 101 displays the commodity name and the price represented by the commodity sales data copied or decompressed in the registration processing area on the display 13a or the touch panel 22.

In Act 45, the processor 101 determines whether or not the commodity transaction represented by the commodity transaction file 510 stored in the main memory 102 is ended. Specifically, the processor 101 determines whether or not payment data are input for settlement. If no payment data are input, the processor 101 determines that the result of the determination of Act 45 is ‘No’ and repeatedly carries out Act 45. In this way, the processor 101 waits for the input of payment data in Act 45. Moreover, if payment data are input, the processor 101 determines that the result of the determination of Act 45 is ‘Yes’ and consequentially proceeds to carry out Act 46. Further, if the barcode data of a commodity are output from the scanner 11 or 21 when the processor 101 is in the wait state of Act 45, the processor 101 may add the sales data of the commodity identified according to the commodity code contained in the barcode data to the registration processing area.

In Act 46, according to the payment data, the processor 101 carries out a settlement process for the commodity transaction of which commodity sales data is copied or decompressed in the registration processing area. During the settlement process, the processor 501 extracts the various data that should be recorded on a receipt (hereinafter referred to as receipt recorded data). Which data should be taken as receipt recorded data is optional, for example, the receipt recorded data refer to the data recorded on a paper receipt issued by another existing POS apparatus.

In Act 47, the processor 101 carries out a receipt issuing process. The receipt issuing process is different depending on whether the settlement program. P11 is the first type or the second type.

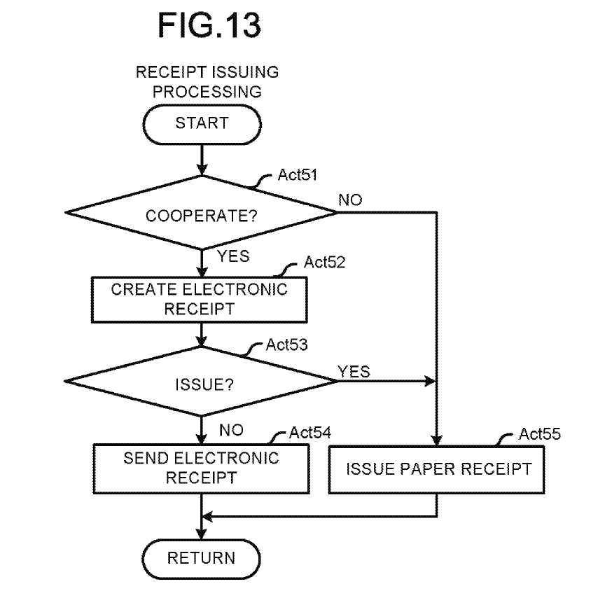

FIG. 13 is a flowchart illustrating a receipt issuing process carried out by the processor 101 in a case where the settlement program P11 is the first type settlement program.

In Act 51, the processor 101 determines whether or not the customer 4 desires to cause the self-service registration system to cooperate with the electronic receipt system. Specifically, the processor 101 checks the association flag F contained in the commodity transaction file 510 stored in the main memory 102. If the association flag F is set to ‘1’, the processor 101 determines that the result of the determination of Act 51 is ‘Yes’ and consequentially proceeds to carry out Act 52.

In Act 52, the processor 101 creates electronic receipt data generated by depicting the receipt recorded data extracted in Act 46 in a structured form such as XML (Extensible Markup Language) form or CSV (Comma-Separated Values) form. In this way, with the execution of a process by the processor 101 based on the first type settlement program P11, the computer having the processor 101 as the main unit thereof functions as a second creation module.

In Act 53, the processor 101 determines whether or not to issue a paper receipt. Specifically, the processor 101 displays, on the display 13a or the touch panel 22, a screen to inquire of the customer 4 about whether or not to issue a paper receipt. If the keyboard 12 or the touch panel 22 is operated to indicate no need for the issuing of a paper receipt, the processor 101 determines that the result of the determination of Act 53 is ‘No’ and consequentially proceeds to carry out Act 54. The processor 101 may proceed to carry out Act 54 after carrying out Act 52, ignoring Act 53.

In Act 54, the processor 101 sends the electronic receipt data generated in Act 52 to the electronic receipt server 80. Specifically, the processor 101 generates a transfer file including the electronic receipt data created in Act 52 and the self-service registration ID contained in the commodity transaction file 510 stored in the main memory 102. Moreover, the processor 101 causes the communication interface 104 to send the transfer file to the electronic receipt server 80 via the LAN 70, the route 60 and the network 200 using a protocol such as FTP (File Transfer Protocol). In this way, with the execution of a process by the processor 101 based on the first type settlement program P11, a function as a second sending module is achieved through the association of the computer having the processor 101 as the main unit thereof with the communication interface 104.

If the sending of the transfer file is ended, the processor 101 ends the receipt issuing process and proceeds to carry out Act 48 shown in FIG. 12.

Contrarily, if the issuing of a paper receipt is indicated through an input, the processor 101 determines that the result of the determination of Act 53 is ‘Yes’ and consequentially proceeds to carry out Act 55. If the association flag F is set to ‘0’, the processor 101 determines that the result of the determination of Act 51 is ‘No’ and consequentially proceeds to carry out Act 55, ignoring Acts 52 and 53.

In Act 55, the processor 101 controls the printer 14 or 24 to issue a paper receipt. If the issuing of a paper receipt is ended, the processor 101 ends the receipt issuing process and proceeds to carry out Act 48 shown in FIG. 12.

In this way, with the execution of a process by the processor 101 based on the first type settlement program P11, the POS apparatus 10 or 20 functions as a second settlement apparatus.

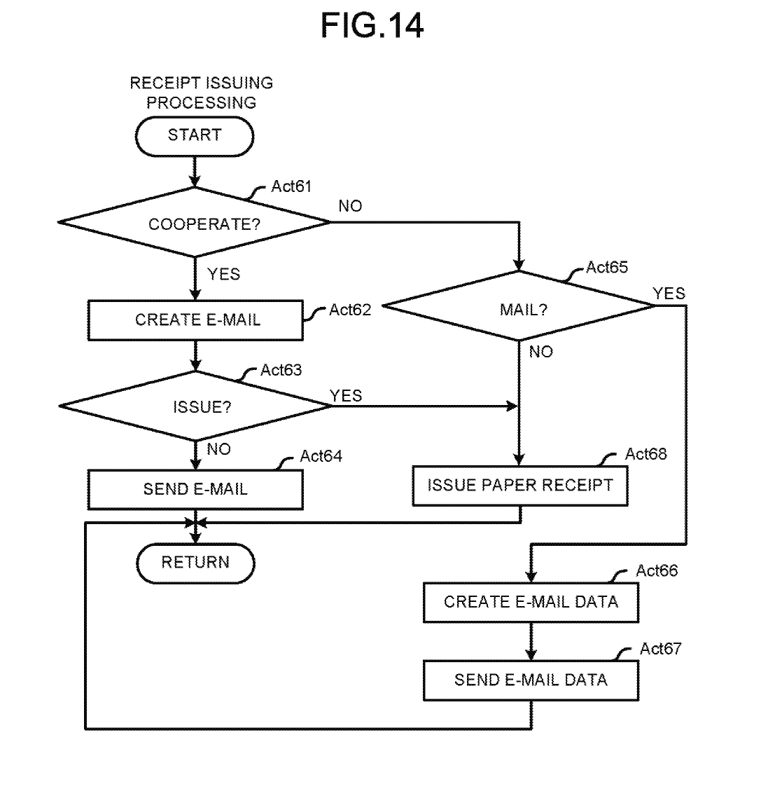

FIG. 14 is a flowchart illustrating a receipt issuing process carried out by the processor 101 when the settlement program P11 is the second type settlement program.

In Act 61, the processor 101 determines whether or not the customer 4 desires to cause the self-service registration system to cooperate with the electronic receipt system, like in Act 51. If the association flag F is set to ‘1’, the processor 101 determines that the result of the determination of Act 61 is ‘Yes’ and consequentially proceeds to carry out Act 62.

In Act 62, the processor 101 creates e-mail data generated by depicting the receipt recorded data extracted in Act 46 and the self-service registration ID contained in the commodity transaction file 510 stored in the main memory 102 in an unstructured form. The unstructured form may be a text form or a PDF (Portable Document Format) form. Further, the processor 101 sets the destination of the e-mail data as an e-mail address assigned to the electronic receipt server 80. In this way, with the execution of a process by the processor 101 based on the second type settlement program P11, the computer having the processor 101 as the main unit thereof functions as a first creation module.

In Act 63, the processor 101 determines whether or not to issue a paper receipt, like in Act 53. If an input indicates that there is no need to issue a paper receipt, the processor 101 determines that the result of the determination of Act 63 is ‘No’ and consequentially proceeds to carry out Act 64. The processor 101 may proceed to carry out Act 64 after carrying out Act 62, ignoring Act 63.

In Act 64, the processor 101 sends the e-mail data created in Act 62 to the electronic receipt server 500 from the communication interface 104. A protocol such as SMTP (Simple Mail Transfer Protocol) is used during the sending of the e-mail data. If the sending of the e-mail data is ended, the processor 101 ends the receipt issuing process and consequentially proceeds to carry out Act 48 shown in FIG. 12. In this way, with the execution of a process by the processor 101 based on the second type settlement program P11, a function as a first sending module is achieved through the operation of the computer having the processor 101 as the main unit thereof with the communication interface 104.

Contrarily, if the association flag F is set to ‘0’, the processor 101 determines that the result of the determination of Act 61 is ‘No’ and consequentially proceeds to carry out Act 65.

In Act 65, the processor 101 determines whether or not to notify a receipt in an e-mail. Specifically, the processor 101 displays, on the display 13a or the touch panel 22, a screen to inquire the customer 4 of whether or not the customer 4 prefers a receipt notification by an e-mail. If the keyboard 12 or the touch panel 22 is operated to indicate the notification of a receipt by an e-mail, the processor 101 determines that the result of the determination of Act 65 is ‘Yes’ and consequentially proceeds to carry out Act 66.

In Act 66, the processor 101 generates e-mail data generated by depicting the receipt recorded data extracted in Act 46 in an unstructured form such as a text form. Further, the processor 101 sets the destination of the e-mail data as an e-mail address appended to the commodity transaction file 510 stored in the main memory 102. As described above, the e-mail address is designated by the customer 4.

Further, if no e-mail address is designated by the customer 4, then no e-mail address is appended to the commodity transaction file 510 stored in the main memory 102. In this case, the processor 101 displays, on the display 13a or the touch panel 22, a screen to prompt the customer 4 to input an e-mail address. If an e-mail address is input through the keyboard 12 or the touch panel 22, the processor 101 sets the e-mail address as the destination of the e-mail data.

Further, the processor 101 may determine that the result of the determination of Act 65 is ‘NO’ if no e-mail address is appended to the commodity transaction file 510 stored in the main memory 102. Contrarily, the processor 101 may determine that the result of the determination of Act 65 is ‘Yes’ if an e-mail address is appended to the commodity transaction file 510 stored in the main memory 102.

In Act 67, the processor 101 sends the e-mail data created in Act 66 to the e-mail server 500 or another e-mail server using a protocol such as SMTP. If the sending of the e-mail data is ended, the processor 101 ends the receipt issuing process and consequentially proceeds to carry out Act 48 shown in FIG. 12.

If the keyboard 12 or the touch panel 22 is operated to indicate that there is no need to provide a receipt by an e-mail, the processor 101 determines that the result of the determination of Act 65 is ‘No’ and consequentially proceeds to carry out Act 68. Further, if the issuing of a paper receipt is indicated through an input in Act 63, the processor 101 determines that the result of the determination of Act 63 is ‘Yes’ and consequentially proceeds to carry out Act 68.

In Act 68, the processor 101 controls the printer 14 or 24 to issue a paper receipt. If the issuing of a paper receipt is ended, the processor 101 ends the receipt issuing process and proceeds to carry out Act 48 shown in FIG. 12.

In Act 48, the processor 101 sends a settlement end command to the support server 50.

Then, the processor 101 ends the process based on the settlement program P11.

In this way, when the processor 101 executes a process based on the second type settlement program P11, the POS apparatus 10 or 20 functions as a first settlement apparatus.

The settlement end command is transmitted to the support server 50 via the LAN 70.

Further, the processor 501 proceeds to carry out Act 36 after sending the commodity transaction file in Act 35 shown in FIG. 11.

In Act 36, the processor 501 determines whether or not a settlement end command is received. If the settlement end command sent from the designated POS apparatus is transmitted to the support server 50 via the LAN 70, as described above, the settlement end command is received by the communication interface 504. The communication interface 504 writes the settlement end command into the main memory 502 and notifies the processor 501 that the settlement end command is written in the main memory 502. The processor 501 determines that the result of the determination of Act is ‘No’ if there is no notice and consequentially repeatedly carries out Act 36. That is, the processor 501 waits to receive a settlement end command in Act 36. Moreover, if the notice is received, then processor 501 determines that the result of the determination of Act 36 is ‘Yes’ and consequentially proceeds to carry out Act 37.

In Act 37, the processor 501 sends the settlement end command stored in the main memory 502 to the portable information terminal 400 from the communication interface 504.

In Act 38, the processor 501 deletes the commodity transaction file 510 sent in Act 35 from the transaction file region W32. Alternatively, the processor 501 may store the commodity transaction file 501 deleted from the transaction file region W32 in a history region secured in the auxiliary memory device 503.

Then, the processor 501 ends the process based on the self-service registration server program P31.

Here, the processor 401 in the portable information terminal 400 is in the wait state described in Act 12 of FIG. 10 during the period in which the processor 101 in the POS apparatus 10 or 20 carries out the process shown in FIG. 12. If the settlement end command sent from the support server 50 is received by the wireless unit 406 and the receiving of the settlement end command is notified, then the processor 401 determines that the result of the determination of Act 12 is ‘Yes’ and consequentially proceeds to carry out Act 13. As the received data is not commodity sales data, the processor 401 determines that the result of the determination of Act 13 is ‘No’ and consequentially proceeds to carry out Act 15.

In Act 15, the processor 401 determines whether or not the received data is a settlement end command. If a settlement end command is received as described above, the processor 401 determines that the result of the determination of Act 15 is ‘Yes’ and consequentially proceeds to carry out Act 16. Further, if the received data is neither commodity sales data nor a settlement end command, then the processor 401 determines that the result of the determination of Act 15 is ‘No’ and consequentially proceeds to a process corresponding to the received data.

In Act 16, the processor 401 deletes the registration screen displayed on the touch panel 404.

Then, the processor 401 ends the process based on the self-service registration terminal program P21.

When the electronic receipt server 80 provides a service of the electronic receipt system, the processor 801 carries out a process based on the electronic receipt server program P41.

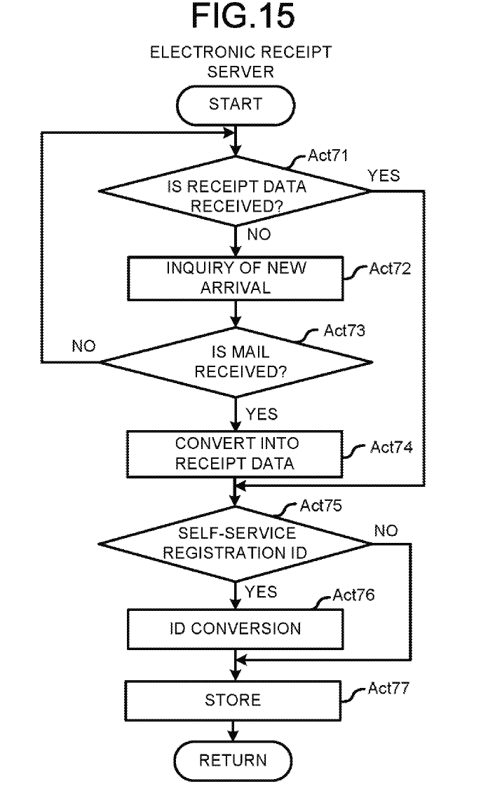

FIG. 15 is a flowchart illustrating a process carried out by the processor 801 based on the electronic receipt server program P41.

In Act 71, the processor 801 determines whether or not electronic receipt data is received. As described above, if the electronic receipt data sent from the designated POS apparatus are transmitted to the electronic receipt server 80 via the network 200, the electronic receipt data are received by the communication interface 804. The communication interface 804 writes the electronic receipt data into the main memory 802 and notifies the processor 801 that the electronic receipt data is written in the main memory 802. In this way, the communication interface 804 functions as an example of a second reception module. Moreover, if there is no notice, then processor 801 determines that the result of the determination of Act 71 is ‘No’ and consequentially proceeds to carry out Act 72.

In Act 72, the processor 801 inquires the e-mail server 500 of whether or not a new e-mail arrives from the communication interface 804 via the network 200. In response to the inquiry, the e-mail server 500 transfers newly arrived e-mail data to the electronic receipt server 80 via the network 200. The newly arrived e-mail data here refers to e-mail data that contain an e-mail address designating the electronic receipt server 80 as a destination and have not been transmitted to the electronic receipt server 80. E-mail data transferred in this way are received by the communication interface 804 and stored in the auxiliary memory device 803. Moreover, in this case, the communication interface 804 notifies the processor 801 of information indicating that e-mail data is received. In this way, with the execution of a control process by the processor 801 based on the electronic receipt server program P41, the computer having the processor 801 as the main unit thereof functions as a receiving control apparatus. A function as a first reception module for receiving e-mail data is achieved through the association of the processor 801 with the communication interface. That is, the electronic receipt server program P41 acts as a control program.

In Act 73, the processor 801 determines whether or not e-mail data are received. Herein, if no notice on the receiving of the e-mail data is received from the communication interface 804 as described above, the processor 801 determines that the result of the determination of Act 73 is ‘No’ and consequentially returns to carry out Act 71.

In this way, the processor 801 waits to receive electronic receipt data or e-mail data in Act 71-Act 73. The processor 801 determines that the result of the determination of Act 73 is ‘Yes’ according to the notice sent from the communication interface 804 on the receiving of newly arrived e-mail data and consequentially proceeds to carry out Act 74.

In Act 74, the processor 801 converts the e-mail data received in the way described above and stored in the auxiliary memory device 803 into electronic receipt data. Specifically, the processor 801 extracts the receipt recorded data depicted in the text of a targeted e-mail data in an unstructured form. Moreover, the processor 801 creates electronic receipt data generated by depicting the extracted receipt recorded data in a structured form. The processor 801 proceeds to carry out Act 75 after the currently received e-mail data are all converted to electronic receipt data. In this way, with the execution of a process by the processor 801 based on the electronic receipt server program P41, the computer having the processor 801 as the main unit thereof functions as a conversion module.

Further, if a notice is sent from the communication interface 804 to indicate that electronic receipt data is received, the processor 801 determines that the result of the determination of Act 71 is ‘Yes’ and consequentially proceeds to carry out Act 75 without carrying out Act 74.

The electronic receipt server 80 also manages the electronic receipt data sent from a POS apparatus different from the POS apparatuses 10 and 20 (hereinafter referred to as an out-of-system POS apparatus) An out-of-system POS apparatus sends a transfer file which contains an electronic receipt ID and electronic receipt data obtained by depicting receipt recorded data in a structured form to the electronic receipt server 80 via the network 200. Alternatively, the out-of-system POS apparatus sends e-mail data in the text of which receipt recorded data and an electronic receipt ID are depicted. Further, the POS apparatus 10 or 20 may further additionally have the foregoing functions of the out-of-system POS apparatus. That is, the POS apparatus 10 or 20 may additionally have a function of sending the electronic receipt server 80 a transfer file which contains an electronic receipt ID and electronic receipt data relating to a normal commodity transaction process, based on, for example, the commodity registration executed by the POS apparatus 10 or 20. Alternatively, the POS apparatus 10 or 20 may additionally have a function of sending the electronic receipt server 80 e-mail data in the text of which an electronic receipt ID and receipt recorded data relating to a normal commodity transaction process based on, for example, the commodity registration executed by the POS apparatus 10 or 20 are depicted. Thus, data associated with a self-service registration ID and data associated with an electronic receipt ID are mixed in the electronic receipt data sent from the electronic receipt server 80 or the electronic receipt data obtained in Act 74.

In Act 75, the processor 801 determines whether or not the data associated with the received electronic receipt data or the electronic receipt data obtained in Act 74 is a self-service registration ID. If so, the processor 801 determines that the result of the determination of Act 75 is ‘Yes’ and consequentially proceeds to carry out Act 76.

In Act 76, the processor 801 converts the self-service registration ID into an electronic receipt ID. Specifically, the processor 801 retrieves the association table 820 stored in the association table region W42 of the auxiliary memory device 803 by using the self-service registration ID associated with the electronic receipt data as a keyword. Moreover, the processor 801 uses the electronic receipt ID contained in the data record found in the retrieval as a converted ID.

Then, the processor 801 proceeds to carry out Act 77. Further, if the electronic receipt ID is associated with the received electronic receipt data or the electronic receipt data obtained in Act 74, then the processor 801 determines that the result of the determination of Act 75 is ‘No’ and consequentially proceeds to carry out Act 77 without carrying out Act 76.

In Act 77, the processor 801 creates an electronic receipt file 810 containing the received electronic receipt data or the electronic receipt data obtained in Act 74 and the electronic receipt ID and stores the created electronic receipt file 810 in the electronic receipt region W41. In this way, with the execution of the foregoing process by the processor 801 based on the electronic receipt server program P41, the computer having the processor 801 as the main unit thereof functions as a first control module and a second control module.

Then, the processor 801 ends the process based on the electronic receipt server program P41.

When a receipt 200 is requested by any information terminal (view terminal) including the portable information terminal 400 via the network, the electronic receipt server 80 enables the receipt to be displayed on the information terminal. The operations carried out by the electronic receipt server 80 at this time may be similar to those carried out by an existing electronic receipt server. As an example, the processor 801 executes the following process. The processor 801 authenticates the viewer using an electronic receipt ID. The processor 801 selects, according to a predetermined rule, the one of the electronic receipt files 810 stored in the electronic receipt region W41 in which the electronic receipt ID of the viewer is contained. The rule is assumed to be, for example, ‘storage date and time is the latest’. The processor 801 creates, according to the electronic receipt data contained in the selected electronic receipt file 810, a screen file indicating a receipt view screen using, for example, HTML (Hyper-Text Markup Language). The processor 801 sends the created screen file through the network 200 to the information terminal from which the request is sent. In the information terminal, a receipt view screen represented by the screen file is displayed through, for example, a general browser. Further, the processor 801 changes the selected electronic receipt file 810 according to a request from an information terminal and then repeats the foregoing process. In this way, with the execution of the foregoing process by the processor 801, the computer having the processor 801 as the main unit thereof functions as a generation module and a sending module. Further, a function as a sending module is achieved through the association of the processor 801 with the communication interface 804.

Further, the process carried out to display a receipt view screen may also be a process based on an application program dedicated for the execution thereof.

In this way, in the commodity sales processing system of the present embodiment, the electronic receipt server 80 receives both electronic receipt data obtained by depicting receipt recorded data in a structured form and e-mail data obtained by depicting, in an unstructured form, receipt recorded data in the text of the e-mail data. If electronic receipt data is received, the electronic receipt server 80 stores the electronic receipt file 810 containing the electronic receipt data in the electronic receipt region W41. Further, if e-mail data is received, the electronic receipt server 80 converts the receipt recorded data depicted in the main body of the e-mail data in an unstructured form into electronic receipt data depicted in a structured form. Moreover, the electronic receipt server 80 stores the electronic receipt file 810 containing the electronic receipt data resulting from the conversion in the electronic receipt region W41.

As the foregoing illustrates, the electronic receipt server 80 receives both of electronic receipt data obtained by depicting receipt recorded data in a structured form and e-mail data obtained by depicting, in an unstructured form, receipt recorded data in the text of the e-mail data and uniformly manages receipts indicated by the electronic receipt data and the e-mail data. Moreover, the electronic receipt server 80 enables the customer 4 to view the receipts managed by the electronic receipt server 80 on the same receipt view screen, without distinction between the notification of a receipt with electronic receipt data and the notification of a receipt with e-mail data. Thus, the customer 4 can view the content of a commodity transaction settled in a first type POS apparatus and that of a commodity transaction settled in a second type POS apparatus in the same way without distinction.

Embodiments described herein can be varied as follows:

not limited to an unstructured form and a structured form, the first and the second form may be other different forms;

the first receipt data and the second receipt data may be transmitted to the electronic receipt server 80 separately using an optional method;

the first receipt data and the second receipt data may be transmitted to the electronic receipt server 80 using the same method; and

each of the POS apparatuses 10 and 20 may be replaced by another type of settlement apparatus such as a cash register or an apparatus only having a settlement function, or apart from the POS apparatuses 10 and 20, the another type of settlement apparatus such as a cash register or an apparatus only having a settlement function is also used.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A method for unifying formats of electronic receipts, comprising:
receiving, from a first processing device, first electronic receipt data in a structured data format, the first electronic receipt data containing a user ID and transaction content corresponding to one transaction;
receiving, from a second processing device, second electronic receipt data in a non-structured data format;
converting the received second electronic receipt data into the structured data format, the converted second electronic receipt data containing a user ID and transaction content corresponding to one transaction; and
storing the first electronic receipt data in the structured data format and the second electronic receipt data in the structured data format in a table, each entry of the table containing a user ID and transaction content corresponding to one transaction.

2. The method according to claim 1, wherein
the user ID in the first electronic receipt data is of a first type, and the user ID in the second electronic receipt data is of a second type that is different from the first type, and
the user ID in the second electronic receipt data is converted to the first type, based on a conversion table indicating correspondence between a user ID of the first type and a user ID of the second type, such that the user IDs contained in the entries of the database are unified to the first type.

3. The method according to claim 1, wherein the received second electronic receipt data in the non-structured data format are included in an email, the method further comprising:
extracting the second electronic receipt data in the non-structured data format from the e-mail.

4. The method according to claim 1, wherein
the first electronic receipt data are received under a first transfer protocol, and
the second electronic receipt data are received under a second transfer protocol that is different from the first transfer protocol.

5. The method according to claim 4, wherein
the first transfer protocol is FTP, and the second transfer protocol is SMTP.

6. The method according to claim 1, further comprising:
transmitting an inquiry to the second processing device, wherein
the second electronic receipt data in the non-structured data format are received in response to the inquiry.

7. The method according to claim 1, wherein
the structured data format includes XML format and CSV format, and
the non-structured data format includes text format and PDF format.

8. An electronic receipt server, comprising:
a communication interface configured to receive first electronic receipt data in a structured data format, which contain a user ID and transaction content corresponding to one transaction, and second electronic receipt data in a non-structured data format;
a storage unit; and
a processor programmed to convert the received second electronic receipt data into the structured data format, the converted second electronic receipt data containing a user ID and transaction content corresponding to one transaction, and to store the first electronic receipt data in the structured data format and the second electronic receipt data in the structured data format in a table that is maintained in the storage unit, each entry of the table containing a user ID and transaction content corresponding to one transaction.

9. The electronic receipt server according to claim 8, wherein
the user ID in the first electronic receipt data is of a first type, and the user ID in the second electronic receipt data is of a second type that is different from the first type, and
the processor is further configured to convert the user ID in the second electronic receipt data to the first type, based on a conversion table indicating correspondence between a user ID of the first type and a user ID of the second type, such that the user IDs contained in the entries of the database are unified to the first type.

10. The electronic receipt server according to claim 8, wherein
the received second electronic receipt data in the non-structured data format are included in an email, and
the processor is further configured to extract the second electronic receipt data in the non-structured data format from the e-mail.

11. The electronic receipt server according to claim 8, wherein
the communication interface receives the first electronic receipt data under a first transfer protocol, and the second electronic receipt data under a second transfer protocol that is different from the first transfer protocol.

12. The electronic receipt server according to claim 11, wherein
the first transfer protocol is FTP, and the second transfer protocol is SMTP.

13. The electronic receipt server according to claim 8, wherein
the processor is further configured to control the communication interface to transmit an inquiry of electronic receipt data in the non-structured data format, and
the second electronic receipt data in the non-structured data format are received in response to the inquiry.

14. The electronic receipt server according to claim 8, wherein
the structured data format includes XML format and CSV format, and
the non-structured data format includes text format and PDF format.

15. A non-transitory computer readable medium comprising a program that is executable in a server to cause the server to perform a method for unifying formats of electronic receipts, said method comprising:
receiving, from a first processing device, first electronic receipt data in a structured data format, the first electronic receipt data containing a user ID and transaction content corresponding to one transaction;
receiving, from a second processing device, second electronic receipt data in a non-structured data format;
converting the received second electronic receipt data into the structured data format, the converted second electronic receipt data containing a user ID and transaction content corresponding to one transaction; and
storing the first electronic receipt data in the structured data format and the second electronic receipt data in the structured data format in a table, each entry of the table containing a user ID and transaction content corresponding to one transaction.

16. The non-transitory computer readable medium according to claim 15, wherein
the user ID in the first electronic receipt data is of a first type, and the user ID in the second electronic receipt data is of a second type that is different from the first type, and
the user ID in the second electronic receipt data is converted to the first type, based on a conversion table indicating correspondence between a user ID of the first type and a user ID of the second type, such that the user IDs contained in the entries of the database are unified to the first type.

17. The non-transitory computer readable medium according to claim 15, wherein
the received second electronic receipt data in the non-structured data format are included in an email, and the method further comprises:
extracting the second electronic receipt data in the non-structured data format from the e-mail.

18. The non-transitory computer readable medium according to claim 15, wherein
the first electronic receipt data are received under a first transfer protocol, and
the second electronic receipt data are received under a second transfer protocol that is different from the first transfer protocol.

19. The non-transitory computer readable medium according to claim 18, wherein
the first transfer protocol is FTP, and the second transfer protocol is SMTP.

20. The non-transitory computer readable medium according to claim 15, wherein
the structured data format includes XML format and CSV format, and
the non-structured data format includes text format and PDF format.
